(19) United States
(12) Patent Application Publication
(10) Pub. No.: US 2005/0059460 A1
(43) Pub. Date: Mar. 17, 2005

(54) Gaming device and method with bonus puzzle feature

(76) Inventors: Tony Breen, Las Vegas, NV (US); Jason Poole, Las Vegas, NV (US)

Correspondence Address: Anderson & Morishita, L.L.C., Suite 102, 2725 S. Jones Blvd., Las Vegas, NV, 89146, US

(21) Appl. No.: 10/663,602

(22) Filed: Sep. 16, 2003

(51) Int. Cl. A63F 13/00

(52) U.S. Cl. 463/16

(57) ABSTRACT

A gaming device and method are set forth which includes a puzzle bonus feature. When the feature bonus is triggered, puzzle image fragments are selected and positioned and if they match the image and position, the fragment is locked in position. The selection and positioning of fragments may take place over several bonus rounds and the player is awarded a bonus based upon at least the number of properly positioned fragments to fill out the bonus puzzle image.

### FIELD OF THE INVENTION

The present invention relates to gaming devices and methods which provide for bonus game. More particularly it relates to such devices and methods which include bonus game where the bonus is based upon the random completion of a puzzle-form.

### BACKGROUND

Electro-mechanical slot machines are well known. Mechanical reels include symbols on their reel strips and are driven by stepper motors to rotate and stop presenting symbol combinations on one or more pay lines. Depending upon the pay line(s) symbol combinations, the player has one or more winning combinations or losing combinations. For winning combinations, the player receives an award based upon an established pay schedule (referred to as the “pay table”).

Modernly it has been known to provide a secondary, bonus screen for electro-mechanical slot machines, embodied, for example, as a plasma screen disposed apart from the game display. Based upon a triggering event, the bonus screen selects a bonus for the player.

In addition to the electro-mechanical slot machines, video slot machines are well known and are quite popular with players. In a basic form, the player makes a wager to play the game and enables one or more pay lines on a video display. Upon prompting play, a processor selects and displays game symbols on the display in a matrix form. The symbols on any enabled pay line are compared to the established pay table of winning outcomes to determine if a winning or a losing outcome have been obtained. Where a winning outcome is obtained the player receives an award based upon an established pay table for the game. The player then makes another wager, enables one or more pay lines and plays another game (often referred to as a “hand” or “spin”).

To make such video games more entertaining, it is known to provide certain configurations of bonuses. The bonus may be triggered by a certain combination of symbols on a pay line or scattered on the display (a “scatter prize”) during the play of the base game. It is also known to provide secondary screens for issuing a bonus. These secondary, bonus screens may be embodied as a display separate from the primary, or base, game display or a common display may be used wherein, when the bonus is triggered, the base game display is controlled to display the bonus feature display(s). That is, when the player obtains a certain, predetermined outcome during play of he base game, the game processor displays a bonus screen where the player can select from certain options to obtain their bonus. For example, in one game, the player selects by a touch screen from between several displayed “pigs”, the selected pig, in an animated fashion, revealing the bonus. The bonus can be a fixed amount, usually a function of the amount wagered, or a multiplier which multiplies the amount won.

In games where the bonus is determined by player selection, the player may become frustrated is he/she feels they are consistently making bad selections producing only relatively small bonus awards. There is a need for a game which can reduce the level of frustration from bonuses.

Further there is a need for a game device and method which provides an entertaining bonus feature configured to stimulate interest in the game and entertain not only the player but bystanders, inducing all to play the game.

### SUMMARY OF THE INVENTION

There is, therefore, set forth according to the present invention a game device and method which provides an entertaining and exciting bonus feature.

A gaming device and method is set forth which includes a game display to display a plurality of reels, e.g. five reels. Each reel has defined with respect thereto a plurality of symbols movable with movement of the reels during play of the game to produce a winning, losing and/or bonus triggering outcome. Where the game is played in a casino, a player would make a wager to enable one or more pay lines and based upon the reel symbols displayed, the outcome is one or more of a winning, losing or bonus triggering outcome.

In a preferred embodiment, the device is embodied as a five reel, five pay line, video slot machine-having an electronic display of conventional design to display a three row, five column matrix and where the columns are displayed as reels. The player makes a wager to enable from one to five pay lines and prompts play whereupon the reels are displayed to simulate rotation and to eventually stop to position symbols (or blanks) at each coordinate cell of the matrix. Based upon the symbols aligned along enabled pay lines or scattered in the matrix or simply appearing (scattered), the outcome is a winning, losing and/or bonus triggering outcome.

There is also provided a bonus display to initially display a puzzle image template having N fragments. The display may be a display, separate from the display of the reels or it may be the same display. A processor is configured to randomly select images for said fragments of said puzzle from a data structure storing data representing puzzle fragment matching and non-matching images. For example, the bonus puzzle image may be selected to be consistent with the theme of the game such as the face of a clown formed by a composite of nine image fragments. For the fragments, the processor selects images which either, by their image content and location, fill in a fragment of the composite (match) or they do not (no match). If a selected image matches a puzzle fragment, the processor controls the bonus display to display the puzzle image matching fragment in position. A bonus is issued in, relation to at least the number of matching image fragments which were selected and positioned in the composite. The bonus may also be related to which fragments were positioned in the composite.

The selection process may be repeated a predetermined or random number of times so that the player may see the puzzle template being replaced by the fragment images completing the puzzle image over one or several selection rounds. The number of selection rounds may be based on factors such as a random selection of a number of rounds, the symbol combination which triggered the bonus-feature, amount wagered, selection of hidden value by the player, the number of pay line enabled or the like.

The device and method provides the player with an entertaining bonus where the player observes the puzzle being filled-in. Further the selection of puzzle fragments or pieces is not dependant upon player selection thus eliminating the frustration accompanying a poor bonus selection.

Still further, one or more puzzle images may be selected which are consistent with the theme of the game providing variety to the player.

### BRIEF DESCRIPTION OF THE DRAWINGS

These and other features and advantages will become appreciated as the same becomes understood with reference to the description claims and drawings wherein:

FIG. 1 illustrates an embodiment of a device according to the present invention including a common display;

FIG. 2 illustrates an alternative embodiment of a device according to the present invention including a separate bonus display;

FIG. 3 illustrates a bonus triggering outcome;

FIG. 4 illustrates a first display associated with the bonus feature triggered at FIG. 3;

FIG. 5 illustrates the bonus display for the first bonus image after the first selection round;

FIG. 6 illustrates the bonus display for the first bonus image after a second selection round;

FIG. 7 illustrates a bonus display with a second puzzle image; and

FIG. 8 is a logic diagram for the bonus feature

### DESCRIPTION

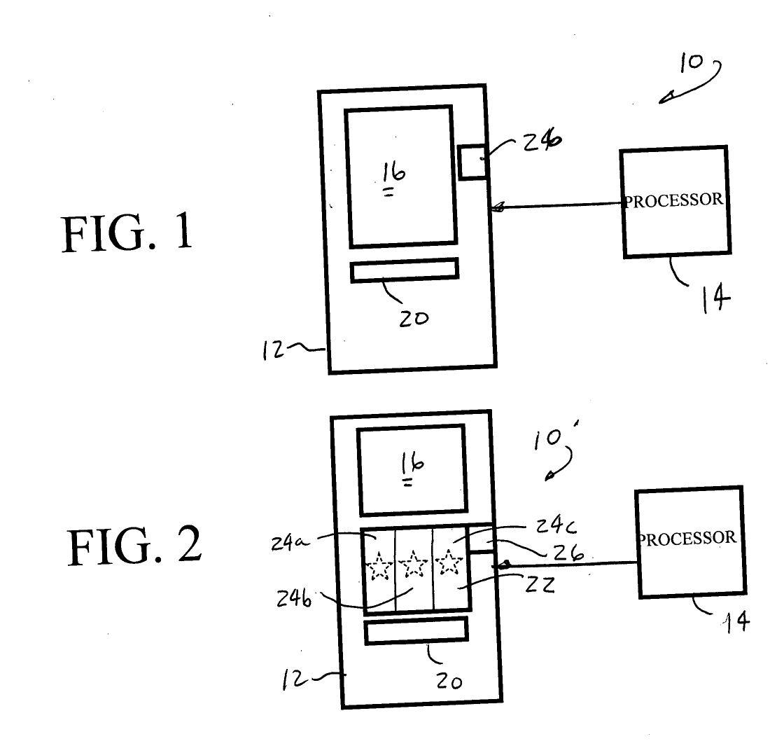

Turning to FIG. 1 there is shown an embodiment of a gaming device 10 according to the present invention. The device 10 is embodied as a gaming machine of the type having a cabinet 12 housing a processor 14 of the type known in the art. Mounted on the cabinet 12 is a display 16 controlled by the processor 14 and which is an electronic display such as a plasma display, VRT, monitor or the like as is known in the art. In the embodiment of FIG. 1 the display 16 is controlled to display the features of a base game and a bonus game according to the present invention.

Not shown in FIG. 1 are wagering means, as is known in the art, such as one or more of a token/coin acceptor, cash validator and acceptor, credit/debit card reader or other suitable means for a player to make wagers to play the game.

While the following description is directed to a casino gaming apparatus where monetary units or their equivalent, such as accumulated gaming credits, are wagered and won, it should be understood that the method can be practiced as a novelty game where fictitious gaming credits are wagered and won such as a computer game, PDA game or other novelty game format.

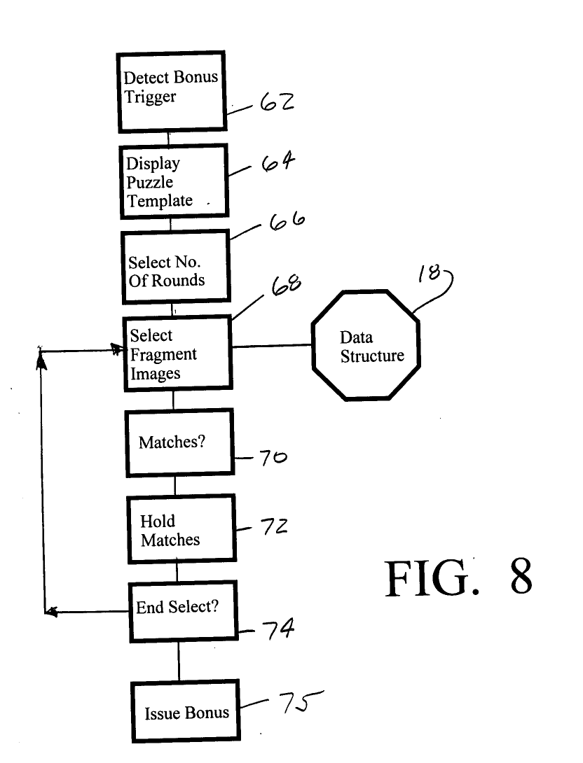

The controlling computer processor 14 includes a random number generator (not shown) and digital data storage device shown as a data structure 18 (FIG. 8). In an alternative embodiment the display 16 may be operated by and communicate with a remotely located processor 14, such as at a remote server. Preferably, the display 16 is embodied as a touch screen display which also provides means for the player to control the play of the game. Alternatively, the play control means' may be any suitable data input means such as game control buttons 20 (shown as a group), keyboard, mouse or the like. For purposes of the following description, these data input means will be referred to as a touch screen display 16.

The device 10 also includes a pay out apparatus (not shown) which may be embodied, as is known in the art, as a hopper device to receive coins/tokens and dispense the same, means for accumulating game play credits, apparatus for writing to a credit voucher, credit card crediting device or the like.

As is known in the art, the device 10 may also include a card reader 26 to read a player's loyalty card and identify the player to a player tracking system processor (not shown).

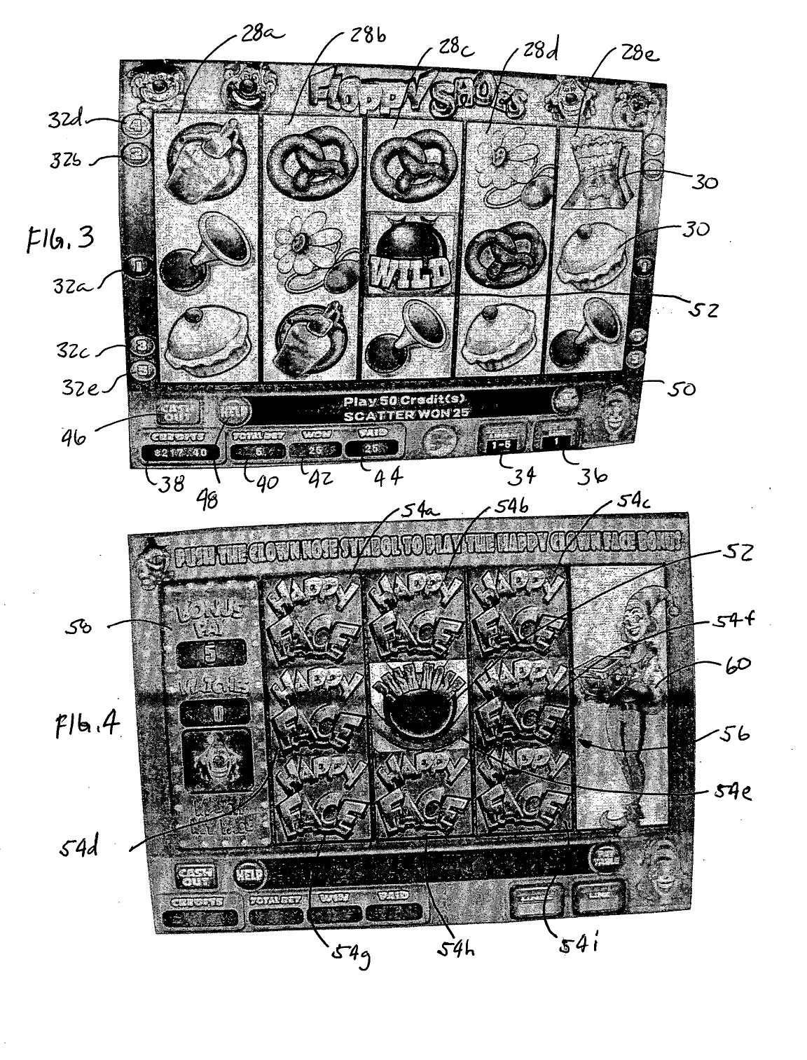

With reference to FIG. 2 there is shown an alternative embodiment of the device 10′. According to this embodiment, the device 10′ has a base game display 22 and a bonus game display 16. The base game display 22 may be an electronic display or may be a location to view electromechanical reels 24a-c which display outcomes for the base game in a manner as hereinafter described.

With reference to FIG. 3, the operation of the base game will now be described.

According to the embodiment described herein, the base game is a video slot machine game of a species which is known generally in the art. The processor 14 controls the display 16 (for the FIG. 1 embodiment) to display outcomes represented by the spinning of five reels 28a-e and where each reel 28a-e displays three game symbols 30.

FIG. 3 also shows the touch screen display 16 for the device 10. To play the game, the player makes a wager to enable from one to five pay lines as is known in the art. Flags 32a-e indicate to the player which pay lines have been enabled by the wager. At the bottom of the display 16 there are also shown certain features relative to the play of the game. At 34 there is a display showing the number of pay lines enabled and at 36 there is displayed the amount of the bet per pay line. Credit meter 38 shows the number of credits (or cash equivalent) available for wagering. At 40 there is shown the total bet for a spin or “hand” of the game. Meter 42 displays the amount the player has won on a spin of the game and paid meter 44 shows the amount the player has won on that spin.

Other touch screen buttons may also be provided as is familiar to those skilled in the art. Cash out button 46, is touched by the player, prompts the device 10 to issue the amount of the credit meter 38 to the player, help button 48 prompts the processor 14 to control the display 16 to display information concerning the certain features of the game for the player and pay table button 50 prompts the processor 14 to display the pay table for the game.

To play the game the player makes a wager to enable one or more of the play lines for the game. Flags 32a-e indicate the lines enabled. The player then prompts play of a spin by touching an appropriate button 20 (play may be prompted by a wager to enable all pay lines with a maximum wager, e.g. 5 credits for each of five pay lines). The processor 14 is configured to randomly select and display symbols 30 on the display in the manner suggested by FIG. 3. As can be appreciated from FIG. 3, the arrangement of five reels 28a-e with three symbols 30 per each reel defines a game display, 3×5 matrix defining fifteen matrix cells, each occupied by game symbols 30. Based upon the combinations of symbols 30 selected and displayed on enabled pay lines or scattered through out the matrix, the payer obtains one of a winning or losing outcome. If the player obtains a winning combination of symbols 30 on an enabled pay line (or scattered within the display), the player receives an award.

In FIG. 3 there is shown another outcome-type which can be obtained by the player in the form of a bonus triggering outcome. According to the present invention, one or more predetermined symbols or symbol combinations are designated as bonus triggers. As but an example, if a bonus trigger symbol 52 is selected and displayed at a predetermined position, i.e. cell, in the game display matrix, the bonus feature of the present invention is triggered and the bonus phase of the game is initiated. It should be understood that other symbols, symbol combinations or locations can be used to trigger the bonus feature of the present invention.

As hereinafter described, and with reference to FIGS. 3-6, the bonus feature includes a bonus image template shown as a partially concealed clown face which is composed of or divided into image fragments, shown as nine fragments 54a-i which occupy the center nine cells of the matrix, e.g. all three rows for columns 2-4 of the display matrix. It should be understood that in lieu of confining the bonus image to a subset of the cells of the display matrix, the image fragments may occupy all fifteen cells of the display matrix or another subset of matrix cells.

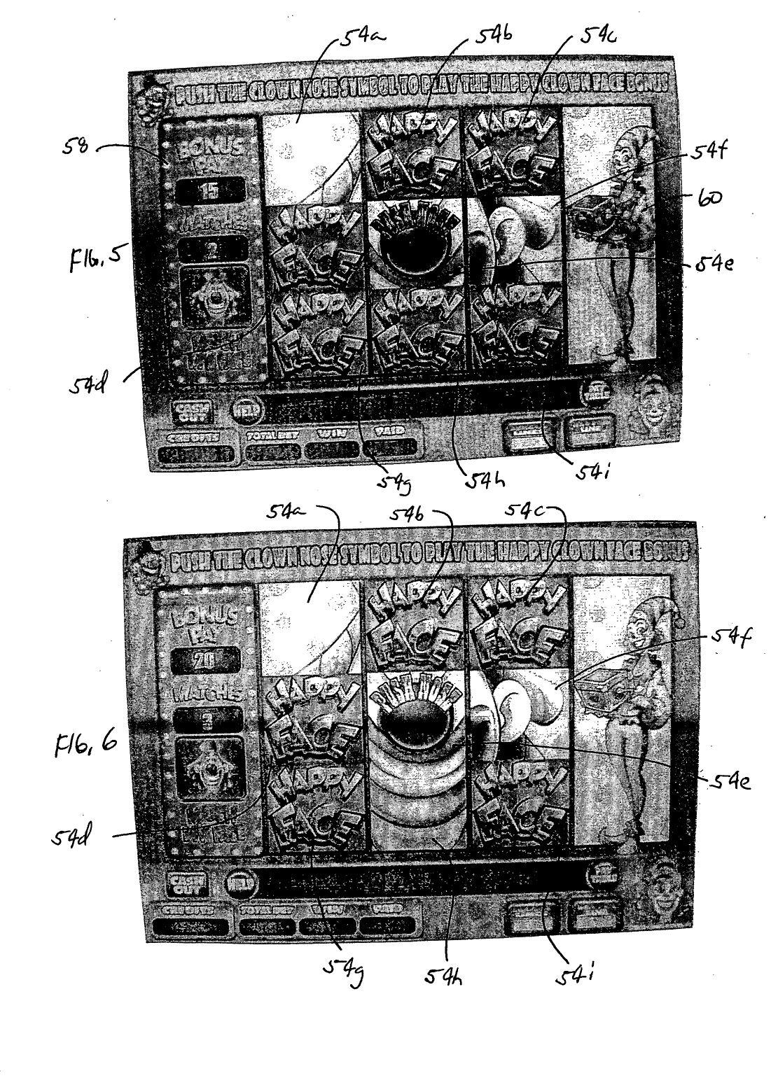

When the bonus feature is triggered, the display 16 segues to a first bonus display as suggested in FIG. 4. The first bonus display displays a bonus matrix 56 of nine matrix cells occupying the center nine cells of the display 16. The first (leftmost); column of the display 16 may display a bonus win meter 58 whereas, the last (rightmost) column may display a bonus animation FIG. 60. Where the bonus feature is triggered by a bonus trigger symbol 52 selected and displayed in the center cell of the display 16 matrix, the bonus trigger symbol 52 may persist to occupy the center position of the bonus, 3×3, matrix 56. As a shown the symbol 52 represents the nose area of the clown face.

With reference to FIGS. 4-6 and 8 the play of the bonus feature will now be described. At 62 the processor 14 has detected the bonus trigger and at 64 controls the display to display the bonus matrix 56, bonus win meter 58 and animation FIG. 60 as shown in FIG. 4. The processor 14 also, at 66 randomly selects a number N of bonus rounds or plays. N may be any number such as 1≦N≦8. The selection of the number of bonus rounds may also be influenced by one or more of (1) the number of pay lines enabled at the time the bonus trigger was selected, (2) the number of bonus trigger symbols obtained (3) the position of the bonus trigger symbol(s) in the display 16 matrix (4) amount of the total wager, (5) the amount of the wager per pay line or the line. N may also be influenced, as described below, according to the progress of the bonus feature.

At 68 the processor 14 randomly selects from the data structure 18 and for the cells of the bonus matrix 56, image fragments 54a-i. The selected fragments 54a-i for the cells are positioned and displayed in the bonus display matrix 56. To enhance the animation and excitement of the bonus feature, the cells or combinations of cells of the bonus matrix 56 may be displayed as spinning reels or a sequence of fragments preceding the display of the fragments 54a-1 selected for the cells of the bonus matrix 66. Alternatively, the processor 14 may only display a fragment when its image, content and position matches the puzzle image template. The processor 14 may be configured to randomly select image fragments 54a-i from the data structure 18 as well as randomly select a cell for each selected fragment 54a-1. Other configurations may be used for the random selection and placement of the image fragments 54a-1.

With continuing reference to FIG. 5, at 70 the processor 14 compares the selected and position fragments 54a-1. If any of the selected fragments 54a-1 match the correct image fragment position and image, those fragments are locked and held in position (remain displayed) at 72. With reference to FIG. 5 it can be seen that in the first round of the bonus feature, two fragments (in addition to the bonus trigger symbol 52) have been selected and properly positioned to fill in two additional cells of the bonus matrix 56 image of the clown face. These correct selections are held in position and remain displayed and the player receives an award based upon the occurrence of obtaining two matches for that round.

At 74 the processor 14 determined if the N bonus rounds have been exhausted. Is so, at 74 the player is issued the award accumulated from all bonus, rounds. The bonus win meter 58 reflects the tally of the bonus amounts awarded at 75.

If at 74, the processor 14 determined that the bonus rounds N have not been exhausted, at 68, and for those non-matching puzzle fragments, the processor at 68 re-selects fragments. The selection for the next round(s) may require a prompt by the player such as by touching the clown's nose image in the bonus matrix 58. With, reference to FIG. 6, there is seen the selection for a subsequent round where an additional match has been obtained (from FIG. 5) and an additional award issued therefore. This procedure continues for the rounds N until the first of (1) exhaustion of the rounds N or (2) full completion of the puzzle image by matching fragments. The total award issued at 75 is based upon the number of matching fragments selected.

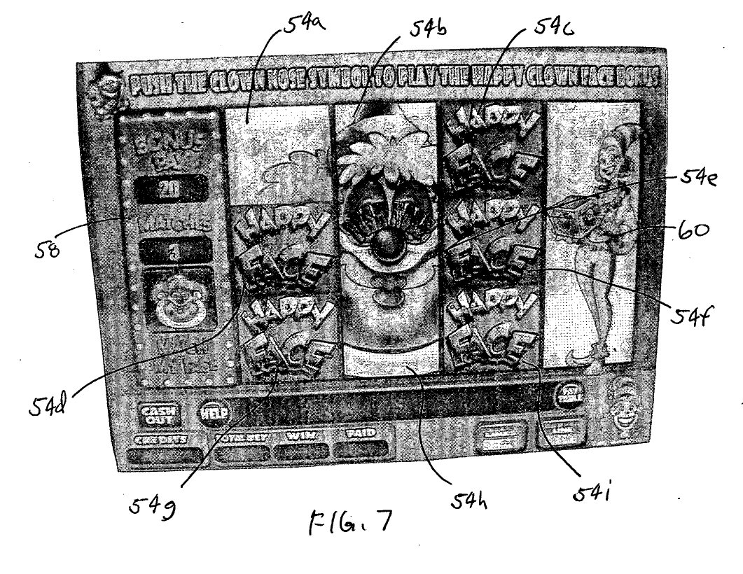

The data structure 18 may include data representing different puzzle image templates such as a different clown face, as partially shown in FIG. 7.

The award issued may be based upon the number of puzzle matching fragments obtained and/or the location of matching fragments. That is, matching certain fragments, e.g. the chin portion of the bonus image, may result in a greater award that certain other fragments.

The number of rounds N may also be influenced by the number of or lack of matches from the sequence of rounds. For example, if the player has two consecutive rounds with no matches, the bonus feature may end. Conversely, if a player obtains in a round two matches, N may be incremented by one or more rounds.

Further, the puzzle template fragments need not include square cells as shown in the drawings. The puzzle piece fragments may be in any geometric shape or in the shape of jigsaw puzzle pieces.

Upon completion of the bonus rounds and the award of the bonus, the processor 14 controls the display 16 to display the base game and the player may play the base game in the manner described above.

While we have shown and described certain embodiments of the present invention it should be understood that it is subject to many modifications and changes without departing from the spirit and scope of the appended claims.

1. A gaming device comprising:
a game display to display a plurality of reels, each reel including a plurality of symbols movable with movement of the reels during play of the game to produce an outcome;
a bonus trigger associated with at least one of said symbols;
a bonus display to display a puzzle image having N fragments; and
a processor configured to (i) randomly select images for said fragments of said puzzle from a data structure storing data representing puzzle fragment images, (ii) if a selected image matches a puzzle fragment controlling the bonus display to display the puzzle image matching fragment and (iii) issue a bonus in relation to at least the number of matching image fragments selected.

2. The gaming device of claim 1 comprising said processor configured to randomly select images from said data structure for puzzle fragments N times where N>2.

3. The gaming device of claim 2 comprising said processor configured to randomly select images from said data structure N times where N is random and N>2.

4. The gaming device of claim 1 comprising said display configured to display said puzzle as an xy matrix of cells where each puzzle fragment is defined by (i) its image fragment and location in the matrix.

5. The gaming device of claim 4 comprising said display configured to display said puzzle as an xy matrix of cells where each puzzle fragment is defined at a cell of the matrix and where x=y and x≧2.

6. The gaming device of claim 5 comprising x=3 to define said matrix to include nine cells.

7. The gaming device of claim 1 comprising said bonus trigger including at least one game symbol defining a puzzle fragment image and said processor configured to display said at least one symbol as a fragment of the puzzle at said display.

8. The gaming device of claim 1 comprising said puzzle image defined by N fragments which, when positioned in a predefined locations, represent said image, said processor configured to (i) randomly select images for said fragments of said puzzle from a data structure storing data representing puzzle fragment images (ii) if a selected image matches a puzzle fragment image and location, controlling the bonus display to display the puzzle image matching fragment and (iii) issue a bonus in relation to at least the number of matching image fragments selected.

10. The gaming device of claim 8 comprising said processor configured to randomly select images from said data structure for non-matching puzzle fragment locations N times where N>2.

11. The device of claim 1 comprising said bonus display is defined by at least a portion of said game display.

12. A method of operating a gaming device comprising the steps of:
displaying a plurality of reels plurality of reels, each reel including a plurality, of symbols movable with movement of the reels during play of the game to produce one of a winning, losing and bonus triggering outcome;
detecting a bonus triggering outcome;
in response to detection of a bonus triggering outcome, displaying a puzzle template having a plurality of puzzle fragments, each fragment representing the position of an image wherein the composite images associated with said fragments define a bonus puzzle image; and
randomly selecting and displaying images for said fragments of said puzzle from a data structure storing data representing puzzle fragment matching and non-matching images, if a selected image matches a puzzle fragment image, controlling the bonus display to display the puzzle image matching fragment in position and issuing a bonus in relation to at least the number of matching image fragments selected.

13. The method of claim 12 comprising displaying said puzzle template as a matrix of puzzle fragment cells.

14. The method of claim 12 comprising serially selecting and displaying images randomly selected from said data structure N times where N>2.

15. The method of claim 12 comprising serially selecting and displaying images randomly selected from said data structure N times where N is randomly selected within a range from 1 to to a predetermined limit L.
